(19) United States
(12) Patent Application Publication
(10) Pub. No.: US 2015/0042945 A1
(43) Pub. Date: Feb. 12, 2015

(54) OPTICAL LENSES

(71) Applicant: Tom Curley, Columbus, OH (US)

(72) Inventor: Tom Curley, Columbus, OH (US)

(21) Appl. No.: 14/453,288

(22) Filed: Aug. 6, 2014

Related U.S. Application Data
(60) Provisional application No. 61/927,177, filed on Jan. 14, 2014.
(60) Provisional application No. 61/862,785, filed on Aug. 6, 2013.

(51) Int. Cl. G02C 7/08; G02C 9/00

(52) U.S. Cl. CPC G02C 7/086; G02C 9/00
USPC 351/57

(57) ABSTRACT

A system for conferring optically corrective characteristics to non-optically corrective eyewear that includes: protective eyewear having at least one non-optically corrective lens; and at least one optically corrective lens that is adapted to be removably mounted on the non-optically corrective lens. The optically corrective lens further includes a thin, flexible film having predetermined optical characteristics; and one or more attachment means for attaching the flexible film to the non-optically corrective lens.

### CROSS-REFERENCE TO RELATED APPLICATIONS

This patent application claims the benefit of U.S. Provisional Patent Application Ser. No. 61/862,785 filed on Aug. 6, 2013 and entitled “Flexible Adhesive Optical Lenses,” and U.S. Provisional Patent Application Ser. No. 61/927,177 filed on Jan. 14, 2014 and entitled “Flexible Optical Lenses”, the disclosures of which are incorporated by reference herein in their entirety and made part of the present U.S. utility patent application for all purposes.

### BACKGROUND OF THE INVENTION

The present invention relates in general to corrective and/or magnifying optical lenses, and more specifically to various flexible, adhesive and non-adhesive films having predetermined optical characteristics that may be used as lenses. These films or lenses may be removably applied to existing eyewear and may be dispensed from one or more dispensing systems or devices that store different shapes and sizes of the removable lenses.

People wear many types of currently existing and commercially available forms of eye protection, eye coverings, and eyewear for purposes other than simply increasing their ability to read and better focus on small, proximally close objects or to see things that are at a distance more clearly. Eyewear and eye protection devices or items that do not typically provide optical magnification/correction characteristics include, for example, ski goggles, safety glasses or goggles such as those worn in manufacturing settings or at gun ranges, sunglasses, eyewear providing UV protection or shading the user's eyes from sunlight, swimming goggles, tanning protection goggles, welding masks, protective faceguards, surgical and medical eyewear, and other similar devices or items.

A large subset of the human population has difficulty reading printed materials and focusing on objects that are in close proximity to the eyes. To address this problem, simple and inexpensive reading glasses are commercially available at many retail locations including grocery stores and drug stores. Similarly, people also use prescription eyewear to improve distance vision. Both reading glasses and prescription glasses, as well as other forms of optical magnification/correction devices, provide optical magnification and/or correction and improved visual clarity to the users thereof. Such glasses often include plastic lens material having optical characteristics that provide these functions, and that are worn on the head when configured as traditional eyewear.

When a person is engaged in an activity in which protective, non-optical eyewear is being used, circumstances often arise in which the user desires or is required to focus on small print or proximally close objects, or focus on distant objects. For example, a person may need to consult a printed map while skiing down a particular run with various forks in the path; a factory worker may need to consult design specifications, safety manuals, or other such materials during the use of heavy machinery; a person may wish to read a novel and/or check e-mails or text messages while engaging in various activities under direct sunlight; and/or a person may simply desire to be able to more clearly see road signs or other items while driving or walking on sunny days. Because non-optical eyewear does not typically include corrective lenses, a person must remove the non-optical eyewear and replace it with corrective glasses such as those previously described. Switching eyewear in this manner is often inconvenient and potentially exposes the person to the harm that the protective eyewear was intended to prevent. Accordingly, there is an ongoing need for corrective lenses that can be used in combination with various types of non-optical protective eyewear and that can be easily mounted thereon and removed therefrom.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a first system for conferring optically corrective characteristics to non-optically corrective eyewear is provided. This system includes protective eyewear that further includes at least one non-optically corrective lens; and at least one optically corrective lens that is adapted to be removably mounted on the non-optically corrective lens. The optically corrective lens further includes a thin, flexible film having predetermined optical characteristics; and at least one adhesive that is operative to attach the thin, flexible film to the non-optically corrective lens.

In accordance with another aspect of the present invention, a second system for conferring optically corrective characteristics to non-optically corrective eyewear is provided. This system includes protective eyewear that further includes at least one non-optically corrective lens; and at least one optically corrective lens that is adapted to be removably mounted on the non-optically corrective lens. The optically corrective lens further includes a thin, flexible film having predetermined optical characteristics and physical dimensions that correspond to a predetermined type of non-optically corrective eyewear; and at least one releasable adhesive that is operative to attach the thin, flexible film to the non-optically corrective lens. A dispensing device for storing the at least one optically corrective lens prior to use is also included.

In still another aspect of this invention, an alternate system for conferring optically corrective characteristics to non-optically corrective eyewear is provided. This system also includes protective eyewear that further includes at least one non-optically corrective lens; and at least one optically corrective lens that is adapted to be removably mounted on the at least one non-optically corrective lens. The at least one optically corrective lens further includes a thin, flexible film having predetermined optical characteristics; and a non-adhesive attachment means for attaching the thin, flexible film to the at least one non-optically corrective lens. The non-adhesive attachment means further comprises electrostatic attachment systems; molecular surface adhesion attachment systems; friction or suction-based attachment systems; pressure adherable attachment systems; physical or mechanical attachment systems; or combinations thereof.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is an exploded, perspective view of optical lenses in accordance with an exemplary embodiment of the present invention, wherein the lenses are used in combination with non-optically corrective sunglasses;

FIGS. 2a-c are illustrations of one packaging system that may be used with the present invention, wherein the optical lenses are provided in a blister pack or other packaging material with a transparent backing for allowing users to try or test the optical material without opening the packaging;

FIG. 3 is an illustration of a dispensing system that may be used with the present invention, wherein the optical lenses are provided in a table top point of sale dispensing device; and

FIGS. 4a-c are illustrations of a dispensing system that may be used with the present invention, wherein the dispenser includes at least one window through which the optical lens may be tested prior to purchase.

### DETAILED DESCRIPTION OF THE INVENTION

Exemplary embodiments of the present invention are now described with reference to the Figures. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

As previously stated, the present invention relates in general to corrective and/or magnifying optical lenses, and more specifically to various flexible adhesive films having predetermined optical characteristics that may be used as detachable lenses on a variety of optically non-corrective substrates. These optical films or lenses may be removably applied to existing non-corrective eyewear and may be dispensed from one or more dispensing systems or devices that store different shapes and sizes of these removable lenses.

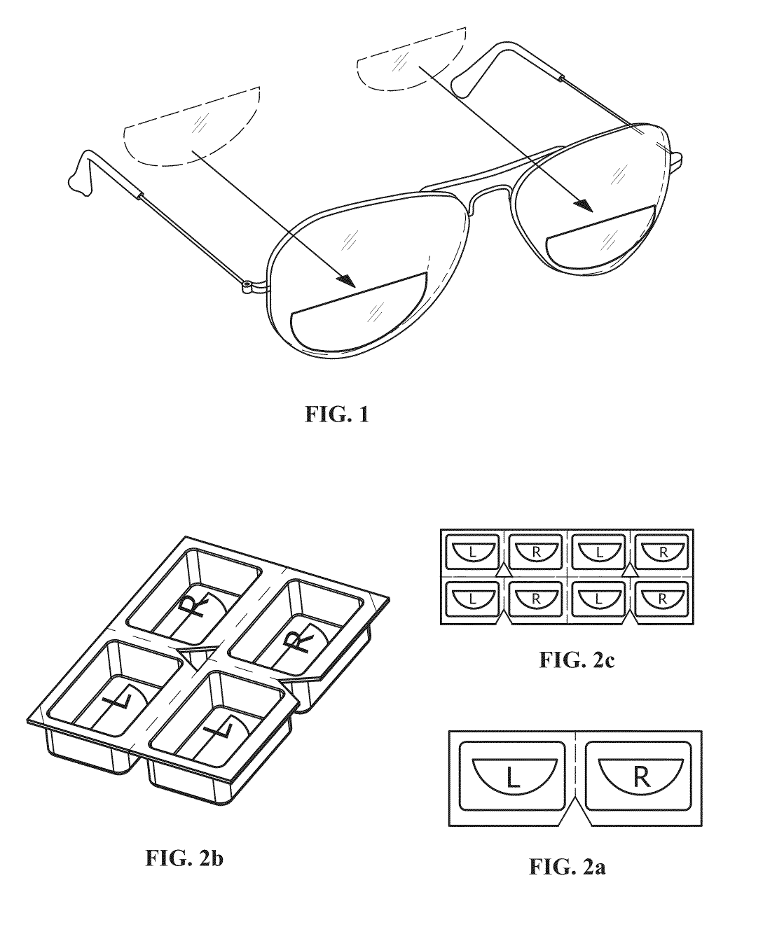

With reference to the Figures, exemplary embodiments of this invention provide a system for conferring optically corrective characteristics to non-optically corrective eyewear. This system typically includes protective eyewear that further includes at least one non-optically corrective lens and at least one optically corrective lens, wherein the at least one optically corrective lens is adapted to be removably mounted on the non-optically corrective lens. The at least one optically corrective lens may be mounted on either the inner or outer surface(s) of the non-optically corrective lens and may be disposed of when the lens becomes dirty or damaged. The optically corrective lens of this invention typically include a thin, flexible film having predetermined or otherwise known optical characteristics and, optionally, physical dimensions that correspond to a predetermined type of non-optically corrective eyewear; and at least one releasable (i.e., non-permanent) adhesive, wherein the adhesive is operative to securely attach the thin, flexible film to the non-optically corrective lens until removal of the thin, flexible film is desired. Non-adhesive attachment means are also an aspect of this invention. As shown in FIGS. 2-4, various dispensing devices for storing the optically corrective lenses prior to use are also an aspect of this invention.

Non-optically corrective eyewear that is compatible with the present invention includes, for example, sunglasses and UV protective glasses; ski goggles; goggles used at gun ranges; swimming goggles; tanning bed goggles, welding glasses; welding masks; protective facemasks; safety glasses; safety eyewear used in manufacturing environments, the military, and medical and surgical environments; and any other protective or accessorial eyewear which may not have certain correction/magnification used for any other application.

The optical lenses of the present invention include various optical materials that possess optical characteristics similar to those found in traditional reading or prescription lenses for glasses. These optical lenses are provided in multiple forms and magnifications (e.g., +1.0 to +3.0 magnification) and/or correction strengths and are manufactured from materials such acrylic, polycarbonate, elastomers, thermoplastics, and/or combinations thereof. Other polymers having known optical characteristics are compatible with this invention such as those disclosed in U.S. Pat. No. 6,170,952, which is incorporated by reference herein, in its entirety, for all purposes. The optical materials may consist of a single or multiple laminates/layers of one or multiple combinations of the above-mentioned materials or other suitable materials. The optical materials may be fabricated in shapes and sizes that are pre-formed for compatibility with existing non-optical eyewear lens configurations; however, in some embodiments, the users of this invention may also cut the materials to conform to desired shapes needed to cover all or portions of existing non-optical eyewear. The optical materials may also be manufactured in different colors, or may be suitable for printing graphics or text thereon without impairing performance of the lens.

In some embodiments of this invention, a removable adhesive backing is provided for use in applying the optical lens to existing eyewear. The adhesive material is transparent, non-distorting, and reusable, and exhibits good water resistance as well as the ability to withstand a wide range of temperatures. An adhesive release liner may include tabs or a similar mechanism to help a user hold and position the lenses before applying them in a desired position on their eyewear or eye protection device. The adhesive is typically pressure sensitive, medical grade, displays high performance features, and does not leave any residue when removed and reapplied. The following references, all of which are incorporated by reference herein for all purposes, include relevant technical disclosure with regard to adhesives-based systems that are compatible with some or all embodiments of this invention: U.S. Pat. No. 8,210,677; U.S. Pat. No. 8,164,835; U.S. Pat. No. 7,798,635; U.S. Pat. No. 7,733,575; U.S. Pat. No. 7,036,929; U.S. Pat. No. 5,748,279; U.S. Pat. No. 5,502,516; U.S. Pat. No. 5,478,824; U.S. Pat. No. 5,153,619; U.S. Patent Pub. No. 2012/0268838; and European Patent No. EP0640523. This invention contemplates the use of additional or alternate known adhesive-based attachment systems that are not specifically disclosed in these references.

In other embodiments of this invention, alternate attachment means are provided for use in applying the optical lens to existing eyewear. Such alternate attachment means include electrostatic attachment systems (including those imparting an electrostatic charge on one or more materials to be joined together or otherwise connected); molecular surface adhesion attachment systems; friction or suction-based attachment systems; pressure adherable attachment systems (e.g., repositionable films); and physical or mechanical attachment systems (e.g., frames or other support structures; force-fitting, fusion of parts, welding, clamping, or other suitable fastening means). The following references, all of which are incorporated by reference herein for all purposes, include relevant technical disclosure with regard to non-adhesives-based systems that are compatible with some or all embodiments of this invention: U.S. Pat. No. 6,170,952; U.S. Pat. No. 6,003,990; U.S. Pat. No. 5,764,333; U.S. Pat. No. 5,677,751; U.S. Pat. No. 4,563,065; U.S. Pat. No. 3,904,281; U.S. Pat. No. 3,033,359; and International Publication No. WO 1995/016220. This invention contemplates the use of additional or alternate known non-adhesive-based attachment systems that are not specifically disclosed in the listed references.

The present invention is intended to address the needs of people with near sightedness (myopia), far sightedness (hyperopia), as well as people exhibiting both near and far sightedness. As such, this invention may be used by people using reading glasses; baby boomers who experience near sightedness due to age; people undergoing LASIK, PRK or other eye correction surgeries; as well as by people using prescription glasses for near vision and/or distance correction. This invention is relevant and applicable to various commercial markets, including: reading; sports; recreational and outdoor eyewear such as, for example, swimming, skiing, and shooting; professional and industrial markets such as, for example, welding, mining, and manufacturing; and/or any other environment that warrants protection of the eye from the surrounding elements. It may also be used in military applications for eye protection devices used in combat or other extreme environments or during training.

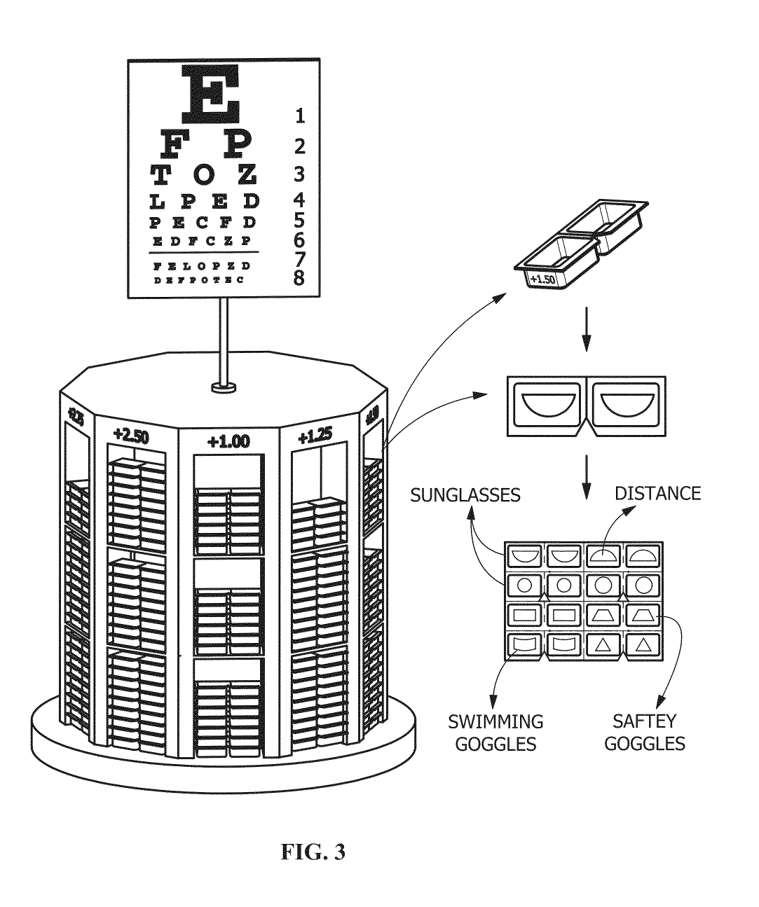

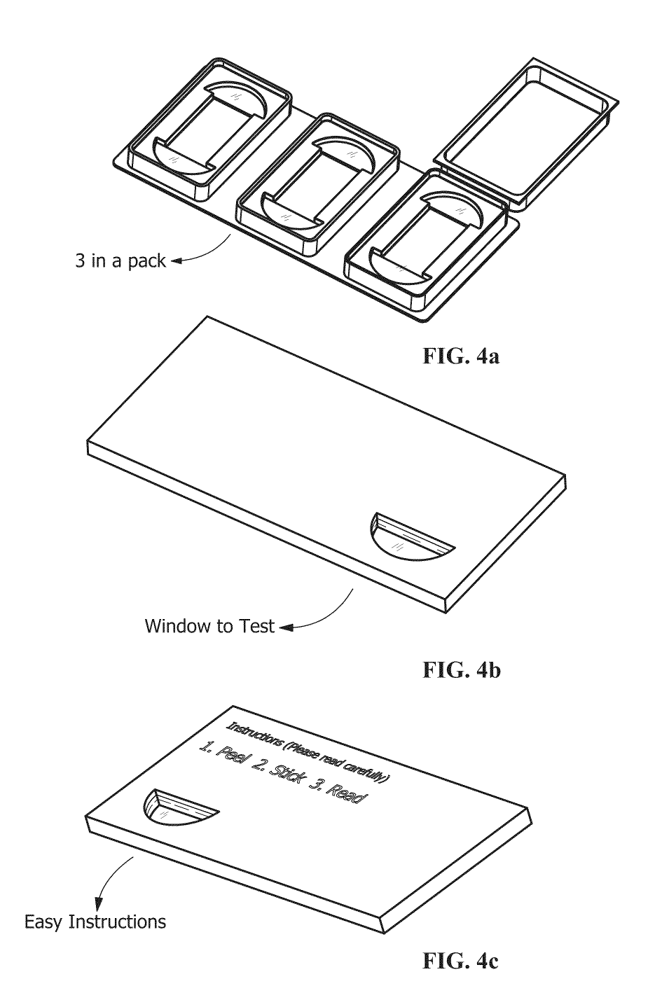

With reference to FIG. 2, the optical lenses of this invention may be packaged in a blister pack or any other packaging configuration having a transparent backing for allowing potential users to try the optical lenses without opening the packaging. The optical lenses may also be dispensed using a device that resembles and functions like a tape dispenser. With reference to FIG. 3, the dispenser may be a table top device holding numerous packs of optical lenses with an eye chart on top for people to use in testing the lenses before buying a particular strength. The dispensing device(s) may also hold the optical lenses in various sizes that have been pre-cut for certain applications such as those previously discussed. With reference to FIG. 4a-c, the optical lenses of the present invention may be provided in a convenient three-pack (or other quantity), wherein the dispenser includes at least one window through which the optical lens may be tested prior to purchase (see FIG. 4b). The dispenser may also include instructions or other information printed thereon (see FIG. 4c).

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1) A system for conferring optically corrective characteristics to non-optically corrective eyewear, comprising:
(a) protective eyewear, wherein the protective eyewear further includes at least one non-optically corrective lens; and
(b) at least one optically corrective lens, wherein the at least one optically corrective lens is adapted to be removably mounted on the at least one non-optically corrective lens; and
wherein the at least one optically corrective lens further includes:
(i) a thin, flexible film having predetermined optical characteristics; and
(ii) at least one attachment means, wherein the at least one attachment means is operative to attach the thin, flexible film to the at least one non-optically corrective lens.

2) The system of claim 1, where in the protective eyewear further includes: sunglasses; UV protective glasses; ski goggles; shooting goggles; swimming goggles; tanning goggles, welding glasses; welding masks; protective facemasks; safety glasses; and safety eyewear used in manufacturing environments, the military, and medical and surgical environments.

3) The system of claim 1, wherein the at least one optically corrective lens is a multilayer construct.

4) The system of claim 1, wherein the thin, flexible film further includes acrylic, polycarbonate, elastomers, thermoplastics, or combinations thereof.

5) The system of claim 1, wherein the at least one attachment means further includes at least one adhesive; and wherein the at least one adhesive is transparent, non-distorting, reusable, exhibits good water resistance, and withstands a wide range of temperatures.

6) A system for conferring optically corrective characteristics to non-optically corrective eyewear, comprising:
(a) protective eyewear, wherein the protective eyewear further includes at least one non-optically corrective lens;
(b) at least one optically corrective lens, wherein the at least one optically corrective lens is adapted to be removably mounted on the at least one non-optically corrective lens; and
wherein the at least one optically corrective lens further includes:
(i) a thin, flexible film having predetermined optical characteristics and physical dimensions that correspond to a predetermined type of non-optically corrective eyewear; and
(ii) at least one adhesive, wherein the at least one adhesive is operative to attach the thin, flexible film to the at least one non-optically corrective lens; and
(c) a dispensing device for storing the at least one optically corrective lens prior to use.

7) The system of claim 6, where in the protective eyewear further includes: sunglasses; UV protective glasses; ski goggles; shooting goggles; swimming goggles; tanning goggles, welding glasses; welding masks; protective facemasks; safety glasses; and safety eyewear used in manufacturing environments, the military, and medical and surgical environments.

8) The system of claim 6, wherein the at least one optically corrective lens is a multilayer construct.

9) The system of claim 6, wherein the thin, flexible film further includes acrylic, polycarbonate, elastomers, thermoplastics, or combinations thereof.

10) The system of claim 6, wherein the at least one adhesive is transparent, non-distorting, reusable, exhibits good water resistance, and withstands a wide range of temperatures.

11) The system of claim 6, wherein the dispensing device further includes at least one opening formed therein and therethrough; wherein the at least one optically corrective lens is visible in the opening; and wherein the at least one optically corrective lens may be tested prior to purchase by viewing through the opening and through the lens.

12) A system for conferring optically corrective characteristics to non-optically corrective eyewear, comprising:
(a) protective eyewear, wherein the protective eyewear further includes at least one non-optically corrective lens; and
(b) at least one optically corrective lens, wherein the at least one optically corrective lens is adapted to be removably mounted on the at least one non-optically corrective lens; and
wherein the at least one optically corrective lens further includes:
(i) a thin, flexible film having predetermined optical characteristics; and
(ii) a non-adhesive attachment means for attaching the thin, flexible film to the at least one non-optically corrective lens.

13) The system of claim 12, further comprising a dispensing device for storing the at least one optically corrective lens prior to use.

14) The system of claim 13, wherein the dispensing device further includes at least one opening formed therein and therethrough; wherein the at least one optically corrective lens is visible in the opening; and wherein the at least one optically corrective lens may be tested prior to purchase by viewing through the opening and through the lens.

15) The system of claim 13, wherein the dispensing device further includes instructional information printed thereon.

16) The system of claim 12, wherein the non-adhesive attachment means further comprises electrostatic attachment systems; molecular surface adhesion attachment systems; friction or suction-based attachment systems; pressure adherable attachment systems; physical or mechanical attachment systems; or combinations thereof.

17) The system of claim 12, where in the protective eyewear further includes: sunglasses; UV protective glasses; ski goggles; shooting goggles; swimming goggles; tanning goggles, welding glasses; welding masks; protective facemasks; safety glasses; and safety eyewear used in manufacturing environments, the military, and medical and surgical environments.

18) The system of claim 12, wherein the at least one optically corrective lens is a multilayer construct.

19) The system of claim 12, wherein the thin, flexible film further includes acrylic, polycarbonate, elastomers, thermoplastics, or combinations thereof.
